(19) United States
(12) Patent Application Publication
(10) Pub. No.: US 2026/0356176 A1
(43) Pub. Date: Nov. 12, 2026

(54) PROFILED SEAL SECTION AND ARRANGEMENT OF THE PROFILED SEAL SECTION BETWEEN A SILL AND A WINDOW PANE IN A SEAL-FREE DESIGN

(71) Applicant: VOLKSWAGEN AKTIENGESELLSCHAFT, Wolfsburg (DE)

(72) Inventors: Frank MÄKELBURG, Gifhorn (DE); Ralph SCHNEIDER, Gifhorn (DE); Michael FRANKE, Beetzendorf (DE)

(21) Appl. No.: 19/487,058

(22) PCT Filed: Feb. 20, 2024
(86) PCT No.: PCT/EP2024/054263

§ 371 Date: Nov. 24, 2025

(30) Foreign Application Priority Data
May 24, 2023 (DE) 10 2023 204 835.3

(51) Int. Cl. B60J 10/36; B60J 10/15; B60J 10/20

(52) U.S. Cl. CPC B60J 10/36; B60J 10/15; B60J 10/20

(57) ABSTRACT

A sealing profile and an arrangement of a sealing profile between a sill and a window pane in a seal-free design. The sealing profile is formed in one piece from an elastomeric material and comprises a main body, at least one fastening element, at least one window-shaft sealing lip and at least one supporting lip, wherein the at least one fastening element and the at least one window-shaft sealing lip as well as the at least one supporting lip are molded on the main body in a material-bonding manner. An arrangement of the sealing profile in a seal-free design in an installation space lying between a sill and a window pane is also described, wherein the sealing profile closes a gap between the sill and the window pane in such a way that an upper sill edge remains seal-free.

### PRIORITY CLAIM

This patent application is a U.S. National Phase of International Patent Application No. PCT/EP2024/054263, filed 20 Feb. 2024, which claims priority to German Patent Application No. 10 2023 204 835.3, filed 24 Mar. 2023, the disclosures of which are incorporated herein by reference in their entireties.

### SUMMARY

Disclosed embodiments relate to a sealing profile and to an arrangement of the sealing profile between a sill and a window pane.

### BRIEF DESCRIPTION OF THE DRAWINGS

Disclosed embodiments will be described in more detail below with reference to drawings, in which:

FIG. 1 illustrates a solution of a sealing profile S and an arrangement of the sealing profile between a movable window pane F and a metal sill formed of sheet metal.

FIG. 2 shows the sealing profile according to at least one disclosed embodiment and the arrangement according to the invention of the sealing profile between the movable window pane F and the metal sill formed from sheet metal.

FIG. 3 shows the sealing profile in an enlarged perspective representation, the section B-B corresponding to that in FIG. 2.

### DETAILED DESCRIPTION

As explained herein, disclosed embodiments relate to a sealing profile and to an arrangement of the sealing profile between a sill and a window pane.

For context of the conventionally known art, it should be noted that that document WO 2009/143 250 A1 describes an outer sealing strip assembly for use on an associated vehicle having a downstanding flange extending from a belt shelf. The sealing strip assembly comprises an elongated sealing-strip or outer sealing-strip assembly having at least one seal lip for engagement with an associated window of the vehicle. A clip secures the sealing strip on the downstanding flange, with the clip including a fastening element for snap mounting the clip on a contour of the sealing strip.

Likewise, the document WO 2017/155 955 A1 discloses a sealing assembly for an associated vehicle. The sealing assembly has a body which includes a substantially planar area dimensioned for abutting engagement with the vehicle. At least one seal lip extends outwardly from a first face of the body to engage an associated surface of a vehicle window. A first hook is provided on the body for receipt over an end tip of the vehicle structural assembly, and a second hook is dimensioned for at least partial receipt through an associated opening around the door window opening. The first hook is positioned over the end tip and then the second hook is rotated until the second hook elastically deforms outwardly and subsequently snap fits into an associated opening and the substantially planar area abuts along the associated structural assembly of the door to preclude movement of the door.

Furthermore, the document DE 10 2006 053 094 A discloses a sealing assembly for sealing window panes and doors of a motor vehicle. The seal has two elastic sealing portions, one of which serves for sealing a lowerable window and the other for sealing a motor vehicle door against the door frame. The two sealing portions are held together by a decorative trim, which may be made of plastic or metal. The sealing portion for the window pane is located in an interlocking manner in the decorative trim and the sealing portion for the door is fitted over a flange of the door frame. For anchoring with the door sealing portion, the decorative trim has in cross section a u-shaped interspace, which, when the decorative trim is placed on the door sealing portion, the flange of which receives a surrounding portion. For a secure firm fit, the flange has regularly spaced clearances, into which tongue-like cut-in engaging portions of the door seal are pressed by a leg of the decorative trim. The multipart construction and the precisely positioned cutting-in of the tongue-like engaging portions makes this seal relatively complex.

The document DE 32 30 142 C2 discloses a window shaft seal for lowerable window panes which can be inserted into a clearance in the outer door part and hooks in place there. The upper part of the seal is formed by a lip which on the one hand lies against the lowerable window pane and on the other hand lies against the outer door part. The material of the sealing profile must be made to have an appropriate stiffness, in particular for staying securely in the clearance in the outer door part on the one hand and sufficiently sealing the window pane on the other hand.

The prior art conventionally known also includes the documents U.S. Pat. No. 5,799,442 A, DE 103 34 768 A1, DE 689 07 478 T2, US 2004/0 018 339 A1, JP 2010-18 130 A, DE 10 2008 053 870 A1 and DE 697 09 592 T2, WO 2007/135 329 A1, DE 199 38 258 A1, DE 10 2005 022 152 A1 and DE 10 2010 034 340 A1.

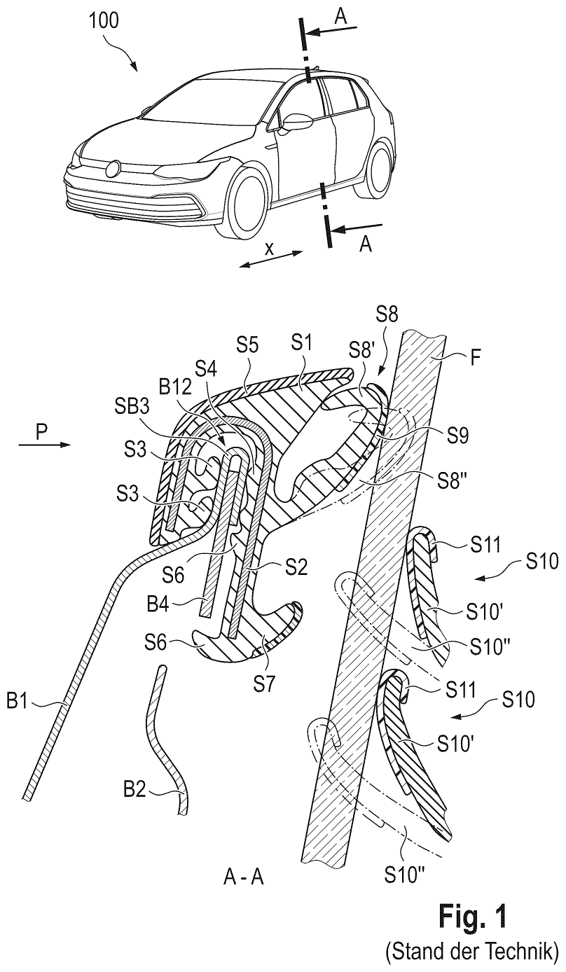

To the contrary, and with this understanding in mind, disclosed embodiments provide a solution of a sealing profile S and an arrangement of the sealing profile between a movable window pane F and a metal sill formed of sheet metal, for example, of a door of a motor vehicle 100, as shown in FIG. 1.

More specifically, as shown in FIG. 1, a section line A-A of a section runs in a substantially vertical direction between the sill and the window pane F as shown in the figure of the motor vehicle 100. The sill has an outer sill part B1 and an inner sill part B2 as a reinforcing sheet part. The outer sill part B1 forms a standing u-shaped bent fold SB3 in which a likewise metal reinforcing part B4 is arranged to ensure the stability of the fold SB3. The bent fold SB3, running in the vertical direction, is also referred to by the skilled person as a vertically directed “standing” flange on which the sealing profile is arranged.

The sealing profile comprises a main body S1 in which a cross-sectionally likewise u-shaped metal insert S2 is arranged. The metal insert S2 is also coated on the inner side and the outer side with a soft sealing material, for example, by coextrusion. The metal insert S2 is carried along during coextrusion.

The sealing material of the S1 main body is, for example, EPDM. The conventional sealing profile also has on both sides of the flange outer clamping lips S3 and slightly protruding clamping surfaces S4 for fastening the sealing profile on the flange. The main body S1 has an elastic rubber protective layer S5, which is, for example, likewise formed from EPDM. The elastic rubber protective layer S5 lies in an exposed area that remains visible after the seal has been installed. The connection between the main body S1 and the rubber protective layer S5 is, for example, likewise achieved by coextrusion.

The main body S1 also has interlocking rear hook S6, wherein one of the rear hooks in the assembled state engages in a first upper opening of the inner sill part B2 and the other second lower rear hook in the assembled state engages in a second lower opening of the inner sill part B2, so that the sealing profile is secured in the sill.

A damping lip S7 opposite the window pane F and made of a material that is less stiff, i.e. more elastic/flexible, than the material of the main body S1 completes the sealing profile. If necessary, it damps contact between the sealing profile and the window pane F.

The actual outer sealing portion, the outer window shaft sealing, is formed by an outer window-shaft sealing lip S8 with an angle, a so-called angled lip, which is firmly connected to the main body S1 via an articulated joint (without reference sign). The window-shaft sealing lip S8 is likewise made of a material that is less stiff than the material of the main body S1.

The softer damping lip S7 and the window-shaft sealing lip S8 are also optionally likewise molded on by coextrusion, wherein in particular thermoplastic elastomers (TPE), particularly optionally on an olefin basis, such as, for example, PP/EPDM (polypropylene/ethylene-propylene-diene rubber), are used as the material. The elastomer may, in this case, also be crosslinked. Other TPE, for example, urethane-based, copolyesters, copolyamides or styrene-block copolymers, can also be used. Such elastomers are dimensionally stable and yet elastically deformable. Even after more than 1000-fold deformation, such elastomers return to their original, undeformed shape.

Reference sign S8′ shows the position of the window-shaft sealing lip when the window pane F is closed and the reference sign S8″ shows the window-shaft sealing lip when the window pane F is open. The window-shaft sealing lip S8 has a sliding coating S9. The connection between the main body S1, the lip S8 and the sliding coating S9 is achieved, for example, by coextrusion. The sliding coating may, in this case be flocking as well as a low-friction TPE, as well as a key of fluorinated polymers (for example, Teflon®), carbon or polyoxymethylene (POM).

Analogous to the outer window-shaft sealing lip S8, two inner window shaft seals are arranged and formed as coated window-sealing abutment lips S10 (compare sliding coating S11 in FIG. 1). The reference sign S10′ shows the position of the window-sealing abutment lip with the window pane F closed and the reference sign S10″ shows the window-sealing abutment lip S10 with the window pane F open.

The description explains the conventional arrangement and configuration of a sealing profile, it being clear from a viewing direction shown by the arrow P that, with the so-called “standing” flange on which the sealing profile sits, the sealing profile of the conventional configuration and arrangement is always visible from the outside. In other words, a sealing profile is visible in the sill area between the window pane F and the sill. If the sealing profile is to be concealed for design reasons, previously metal strips or foils have been used, for example, to cover the visible sealing area, but these must also disadvantageoulsy be fastened and disadvantageoulsy mean additional material is needed.

The aim and object of the invention is to provide, in particular for design reasons, a sealing profile which from the outside, that is to say when the motor vehicle is viewed in a substantially horizontal direction, is arranged between the window pane F and the sill but is not visible.

The starting point of the invention is a sealing profile which is formed in one piece from an elastomeric material, at least comprising a main body, at least one fastening element, at least one window-shaft sealing lip and at least one supporting lip, wherein the at least one fastening element and the at least one window-shaft sealing lip as well as the at least one supporting lip are molded on the main body in a material-bonding manner.

Optionally, the at least one window-shaft sealing lip is formed at its free end as a straight lip or angled lip. An angled lip advantageously opens up improved possibilities for forming abutting surfaces with respect to other components, in a sill and/or a window pane.

Optionally, the sealing profile comprises a first and a second window-shaft sealing lip, which are molded on the main body in a material-bonding manner, wherein the first window-shaft sealing lip, in turn, is formed at its free end as a straight lip or angled lip and the second window-shaft sealing lip is formed at its free end as a straight lip.

Optionally, the main body and the at least one fastening element are formed homogeneously from a stiffer elastomeric material than the at least one window-shaft sealing lip and the supporting lip or the first and second window-shaft sealing lips and the supporting lip.

Furthermore, optionally, on that side of the sealing profile on which the at least one fastening element is arranged, the sealing profile comprises a projection with a supporting surface, wherein the projection is likewise formed in a material-bonding manner from the stiffer elastomeric material of the main body and is molded on the main body. This projection advantageously supports the sealing profile better on a component, according to the invention on an inner surface of the sill.

Optionally, on a side of the sealing profile opposite from the at least one fastening element, the sealing profile comprises a damping lip, wherein the damping lip is likewise formed in a material-bonding manner from the stiffer elastomeric material of the main body and is molded on the main body. The advantages of arranging a damping lip are explained in the description. The sealing profile does not necessarily have to have such a damping lip.

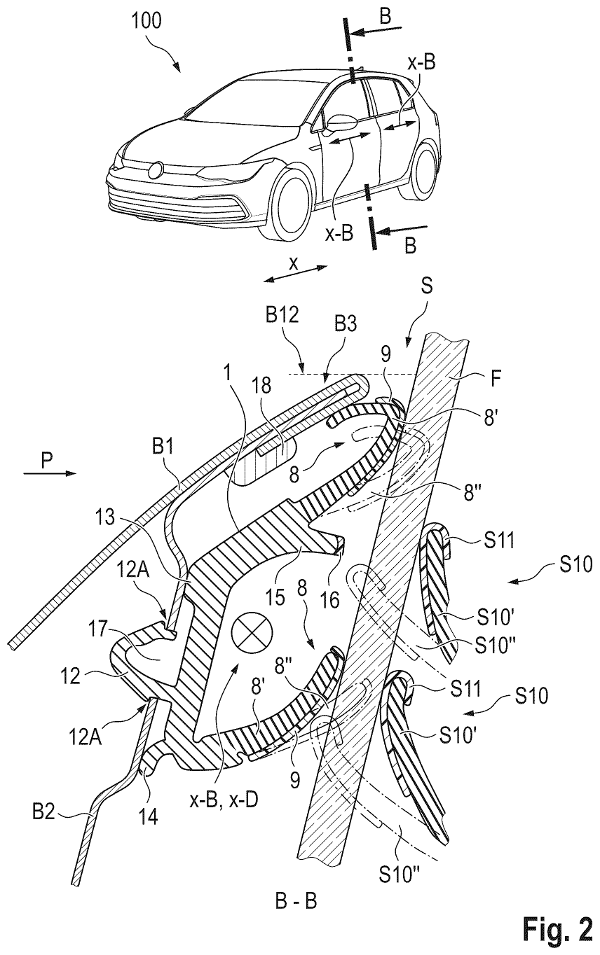

Optionally, in the cross section which is transverse to the longitudinal extent x-D of the sealing profile [according to a section line B-B, FIG. 2], the at least one fastening element is geometrically formed substantially as a “C” shape, wherein a web-like leg of the “C” shape is molded on the main body in a material-bonding manner, while the other leg of the “C” shape forms an open end.

Optionally, it is, in this case also that provided in detail that the two legs, both the web-like leg in the area of the molded-on web and the other leg, have substantially at their open end an undercut, which respectively form a step, wherein the two steps form stepped surfaces directed parallel to the main body and stepped surfaces orthogonal to the main body. In addition to this optional configuration, other solutions may be provided. The solution according to disclosed embodiments may allow the sealing profile in the assembled state to engage behind another component, in particular the sill, using the undercuts. The technical utility of the abutting surfaces formed by the undercuts are explained in more detail in the description.

Optionally, it is also provided that the supporting lip is formed as L-shaped and arranged near the at least one fastening element on that side of the sealing profile on which the at least one fastening element and the projection are also arranged, wherein the at least one fastening element is arranged between the projection and the supporting lip.

Finally, it is optionally provided that the at least one fastening element is formed as a “C”-shaped clip or as a “C”-shaped clip strip, more details of which are given in the description and the technical utility are explained.

Disclosed embodiments also relate to an arrangement of the sealing profile having the aforementioned optional features, wherein an installation space is formed between a sill and a window pane and the sill forms a gap with a predeterminable clearance with respect to the window pane, wherein an upper sill edge extends in its longitudinal extent in relation to the window pane that can be reversibly opened orthogonal to the upper sill edge.

In the arrangement according disclosed embodiments, the sealing profile in an installation state is fastened on an inner side of the sill using at least one fastening element in such a way that the at least one fastening element is inserted through at least one opening provided in the sill (optionally, a plurality of openings), wherein in the installation state at the same time at least one supporting lip is supported on the inner side of the sill and in the installation state furthermore at least one window-shaft sealing lip is positioned in the installation space in such a way that the window-shaft sealing lip closes the gap between the sill and the window pane with the predeterminable clearance both on the window side and on the sill side in a sealing manner, wherein a highest point of the window-shaft sealing lip is arranged in the gap between the sill and the window pane in such a way that the highest point of the window-shaft sealing lip is positioned below an upper sill edge of the sill.

With regard to the arrangement, in the installation state, at the same time, at least one projection of the sealing profile is supported on the inner side of the sill.

The arrangement is optionally further formed in such a way that the at least one window-shaft sealing lip is formed at its free end as a straight lip or as an angled lip, so that the respective angled lip on both sides of the highest point of the window-shaft sealing lip abuts in a sealing manner on the one hand on the sill side below the upper sill edge and on the other hand on the window side.

Further, optionally, the sealing profile comprises a first and a second window-shaft sealing lip, wherein the first window-shaft sealing lip is formed at its free end as a straight lip or as an angled lip and the second window-shaft sealing lip is formed at its free end as a straight lip, wherein the first window-shaft sealing lip in the installation state of the sealing profile closes the gap between the sill and the window pane with the predeterminable clearance in a sealing manner, so that the respective angled lip on both sides of the highest point of the window-shaft sealing lip is positioned below the upper sill edge and abuts in a sealing manner on the one hand on the sill side and on the other hand on the window side, wherein the highest point of the first window-shaft sealing lip is arranged in the gap between the sill and the window pane in such a way that the highest point of the window-shaft sealing lip is positioned below the upper sill edge of the sill, while the second window-shaft sealing lip in the installation state is positioned in the installation space below the first window-shaft sealing lip and its straight lip abuts in a sealing manner only on the window side.

Finally, optionally, an outer sill part is formed in the near-window area as folded, wherein the formed fold forms the seal-free upper sill edge, wherein in a fold gap opposite from the upper sill edge there is arranged the inner sill part, in which the at least one opening is provided, wherein at least the near-window fold is arranged with its upper sill edge oriented with respect to the window pane in three-dimensional space in such a way that the upper sill edge of the sill faces the window pane, while the sill parts of the sill outside the near-window fold are formed and arranged as running substantially coaxial to the window pane.

FIG. 2 shows the sealing profile according to the invention and the arrangement according to disclosed embodiments of the sealing profile between the movable window pane F and the metal sill formed from sheet metal, for example, of a door of a motor vehicle 100. In FIG. 2, a section line B-B of a section runs in a substantially vertical direction between the sill and the window pane F according to the representation of the motor vehicle 100.

The sill has, in turn, an outer sill part B1 and an inner sill part B2 as a reinforcing sheet part. The outer sill part B1 forms a standing u-shaped bent fold B3 in which no metal reinforcing part is arranged to ensure the stability of the fold B3, because the fold B3 is no longer a supporting element of the sealing profile. In this configuration, the inner sill part 2 is inserted at the end into the open “U” of the u-shaped bent fold B3, whereby the outer sill part B1 is stabilized directly by the inner sill part B2.

The bent fold B3, which is oblique to the window pane 1, may also be referred to by the skilled person as a “lying” flange on which the sealing profile, according to the invention, is arranged in a different manner.

A gain in installation space between the inner sill part B2 and the inner side of the window pane F is achieved by the lying arrangement of the flange. In other words, a free installation space of increased size is available between the inner sill part B2 and the inner side of the window pane F and can be advantageously used for arranging the sealing profile.

The sealing profile according to the invention comprises a main body 1 in which, compared to the conventional solution, a metal insert is no longer arranged. In the configuration according to the invention, a metal insert is no longer necessary as a stabilizing insert, since the sealing profile is no longer arranged on the “standing” flange. The positioning of the sealing profile according to the invention is carried out in a different way, as is illustrated below.

The sealing material of the main body 1 is, for example, EPDM.

In the closed state ′ of the window pane F, the sealing profile is arranged in such a way that it is supported on both sides, both on the inner sill part B2 and on the inner side of the window pane F, and is positioned in the available installation space via five or six supporting points, which are explained below.

As a difference from the prior art, in accordance with at least one disclosed embodiment, two window-shaft sealing lips 8 are arranged, which are, optionally, likewise molded on the main body 1 by coextrusion, are now arranged on the window pane side, wherein in particular thermoplastic elastomers (TPE), particularly, optionally, on an olefin basis, such as, for example, PP/EPDM (polypropylene/ethylene-propylene-diene-rubber), are used as the material. The elastomer may, in this case also be crosslinked. Other TPE, for example, urethane-based, copolyesters, copolyamides or styrene-block copolymers, can also be used. Such elastomers are dimensionally stable and yet elastically deformable. Even after more than 1000-fold deformation, such elastomers return to their original, undeformed shape.

The reference signs 8′ show the position of a first upper and a second lower window-shaft sealing lip 8 with the window pane F closed and the reference signs 8″ show the window-shaft sealing lips with the window pane F open.

In a particular way, the first upper window-shaft sealing lip 8 is formed as a straight lip or as an angled lip and the second lower window-shaft sealing lip 8 is formed as a straight lip. The angled lip, formed with the angle, of the first upper window-shaft sealing lip 8 is described in more detail. In particular, the sealing profile is supported on the window pane F until the window pane F has been moved completely below the window-shaft sealing lips 8. With the window pane F closed, according to an optional configuration with two separate window-shaft sealing lips 8 (as shown at the top and bottom), two supporting points are formed, or, if the functionally integrated window-shaft sealing lip 8 already explained before in another optional configuration is formed and used as a single lip, only one window-side supporting point is formed.

The window-side supporting point(s) is/are formed by the abutting surface(s) of the window-shaft sealing lip(s) 8.

The mobility of the window-shaft sealing lip(s) 8 may be achieved by articulated joints in the transition area between the main body 1 and the webs of the window-shaft sealing lips 8.

It should, in this case, be noted that the first upper window-shaft sealing lip 8, optionally formed as an angled lip, is not supported with its upper side in the area of the angle on the main body S1 (compare FIG. 1) of the sealing profile when the window pane F is closed, as previously, but rather abuts on a underside of the inner sill part B2.

Looking from above in a vertical direction into the outer window shaft, this results in a uniformly closed design over the entire length of the sill, that is to say that, in the outer window shaft, which can be kept very narrow, only a small area of the angle of the first upper window-shaft sealing lip 8 is visible, while the sealing profile is not visible at all from the horizontal viewing direction P according to FIG. 2.

The first upper window-shaft sealing lip 8 sits along the sill even just below the upper sill edge of the sill formed by the fold B3. In other words, when a motor vehicle 100 is viewed from a distance, the viewer will assume that the interspace between the sill and the window pane F is formed without a seal. This solution may be referred to as a “Clean Design” because the bodywork itself is freed, that is to say, cleaned of the sealing profiles previously arranged visibly even when viewed from relatively far away.

It is, therefore, a feature of the arranged sealing profile according to disclosed embodiments that, in the assembled state, the highest point of the first upper window-shaft sealing lip 8 is at least flush with the upper sill edge of the sill or even is positioned below the upper edge of the sill.

The window-shaft sealing lips 8 have a sliding coating 9. The connection between the main body 1, the window-shaft sealing lips 8 and the sliding coatings 9 is achieved, for example, by coextrusion. The sliding coating may, in this case, be flocking as well as a low-friction TPE, as well as a key of fluorinated polymers (for example, Teflon®), carbon or polyoxymethylene (POM).

Functionally, the first upper window-shaft sealing lip 8 fulfills the task of protecting the interior space between the sill and window pane F, that is to say, the door interior, from water ingress. The first upper window-shaft sealing lip may also be referred to by the skilled person as a water lip.

The lower window-shaft sealing lip 8 has the function of protecting the interior space between the sill and window pane F, that is to say the door interior, from solid particles (such as dust, coarser dirt et cetera), while at the same time ensuring by the abutment on the window pane F that the window pane F is arranged silently in the door.

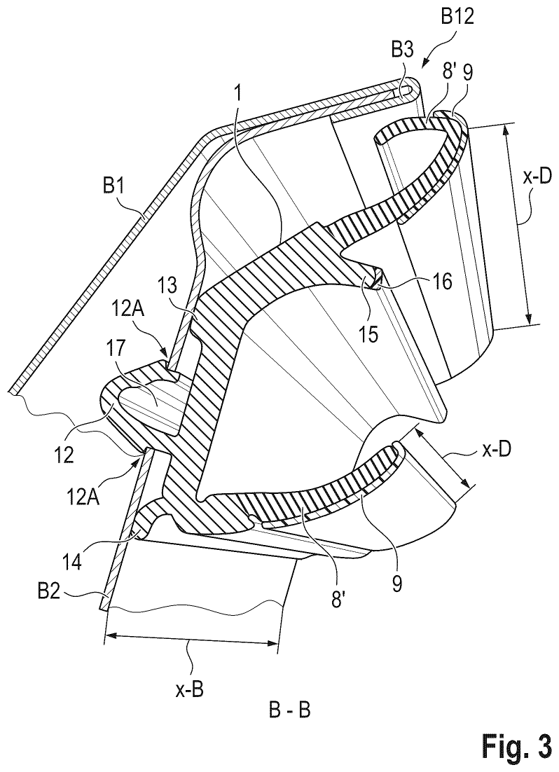

In this respect, it is clear that the formation of the sealing profile with two window-shaft sealing lips 8 is an optional configuration; however, it is disclosed here that the function of the second lower window-shaft sealing lip 8 may also be integrated in the first upper window-shaft sealing lip. The pressing force of such a window-shaft sealing lip 8 with the required functionality is then chosen to be correspondingly higher so that both water and solid particles can be repelled by just one window-shaft sealing lip 8, wherein the window-shaft sealing lip 8 with integrated functions is then positioned in the area of the first upper window-shaft sealing lip 8 shown in FIGS. 2 and 3 and is optionally formed as an angled lip.

FIG. 3 illustrates the sealing profile in an enlarged perspective representation, the section B-B corresponding to that in FIG. 2. In FIG. 2, however, only the sealing profile and the sill are shown, whereas details of the optional configuration of the sealing profile and the longitudinal extent x-D of the sealing profile and the sill illustrated in FIG. 3.

Between the window-shaft sealing lips 8, a damping lip 15, which has a softer coating 16 is arranged on the window pane side. The damping lip 15 consists of the stiffer material of the main body 1 and, by analogy with a fastening element 12, still to be explained below, is likewise molded in one piece on the main body 1 by coextrusion. The front side of the damping lip 15, which has the coating 16, serves as a damping abutting surface for the case in which the window pane F is, for example, in the “open state” and is closed, so that the window pane F is shifted toward the sill. The damping lip 15 advantageously limits this displacement. Softer thermoplastic elastomers (TPE), optionally based on olefins, such as, for example, PP/EPDM (polypropylene/ethylene-propylene-diene rubber), are used, in turn, as the material for the coating 16.

On the sill side, at least four supporting points, which support, or support and fasten, the sealing profile on the inner sill part B2, are provided. Provided as a supporting point on the sill side is the first upper window-shaft sealing lip 8′, which, when the window pane F is closed, optionally abuts with its angled lip both on the window side and on the sill side, so that the first upper window-shaft sealing lip 8′ forms two supporting points. In an advantageous way, the clearance of the gap S between the window pane F and the sill is chosen to be very small. The window-shaft sealing lip 8′ closes the clearance of the gap S by the angle and, as a result of the angular configuration, advantageously abuts in a sealing manner on both sides.

Provided and formed as further supporting points on the sill side are the already mentioned one-piece fastening element 12 and a projection 13, which are still to be explained. In other words, the fastening element 12 and the projection 13 are arranged on one and the same side of the sealing profile.

Also arranged as yet another supporting point is a supporting lip 14, which is likewise still to be explained. This results in a total of four supporting points on the sill side. The supporting lip 14 is attached to the main body 1 again optionally by coextrusion, so that the explanations for the attachment of the window-shaft sealing lips 8 also apply to the supporting lip 14, which is formed as less stiff. The supporting lip 14 is formed as an L-shaped leg, so that a temporary buckling is possible when a force acts on the supporting lip 14, which will be discussed further in connection with the mounting or arrangement of the sealing profile.

In terms of material, the one-piece fastening element 12 and the projection 13 belong to the main body 1, in particular because, like the main body 1, they are likewise formed in the stiffer material compared to the window-shaft sealing lips 8 and the supporting lip 14, for example, EPDM.

The projection 13 has as a supporting point a supporting surface, which supports the sealing profile on the inner sill part B2.

In addition to the other elements, the one-piece fastening element 12 likewise represents an element of the configuration and arrangement of the sealing profile.

The fastening element 12 is formed as a fastening element in the form of a “C” in one piece with the main body 1, wherein the lower web-like leg is in in orthogonal connection with main body 1 running parallel to the inner sill part B2 and formed correspondingly. The upper leg of the “C” runs out as an open end. The two legs together form the “C” shape.

Both the upper leg and the lower leg have in the assembled state by way of extension in a straight line from the edges of an opening 17 in the sheet metal of the sill part B2 an undercut 12A on which, in the assembled state of the sill and sealing profile, the edge of the opening 17 in the sill part B2, more precisely the outer surface of the sill part B2 at the edges of the opening 17, comes into abutment with the surfaces of the undercuts 12A directed toward the opening 17.

During the mounting of the sealing profile, the flexible fastening element 12 is pressed through the opening 16 and engages with the stepped undercuts 12A behind the outer surface of the sill part B2 at the edges of the opening 17 to bring about the assembled state. A worker, in this case, squeezes the legs of the fastening element 12 together so that he can press the fastening element 12 through the opening 17. The projection 13 and also the supporting lip 14 thereby come into abutment with the inner surface of the sill part B2. To be able to push the fastening element 12 completely into the opening 17, the worker will over-press the “L”-shaped supporting lip 14, which is already in abutment. The supporting lip 14 is, therefore, arranged near the fastening element 12 according to exemplary embodiments being molded on just below the fastening element 12. When pressing in the fastening element while simultaneously over-pressing the supporting lip 14, the fastening element 12 engages via the undercuts 12A on the outer surface of the sill part B2. The worker then completes his manipulation and the over-pressed, bent-in supporting lip 14 returns to its only slightly bent-in starting position and thereby exerts a sufficiently great holding force on the fastening element 12, which as a result- and with it the sealing profile-is advantageously reversibly releasably fixed in the inner sill part B2. Once the sealing profile has been mounted, the fastening element 12, the projection 13, the supporting lip 14 and the first upper angular window-shaft sealing lip 8′ are supported (on the sill side and window pane side) and the second lower window-shaft sealing lip 8′ is supported within the installation space between the window pane F and the sill.

It goes without saying that the respective section A-A of the conventional sealing profile and the section B-B of the sealing profile according to the disclosed embodiments only show the cross section of the sealing profiles on the respective section line.

In a way corresponding to their continuous production, the coextruded sealing profiles run in the x-direction x, that is to say, according to the representations in FIGS. 1 and 2, in the longitudinal extent x of the motor vehicle 100.

For clarification, FIG. 3 shows a perspective enlarged representation of the sill and the sealing profile (without the window pane F), which illustrates the strand shape of the sealing profile matching the section B-B. For further understanding of the final explanations, reference FIGS. 2 and 3 together. The reference signs in FIG. 3 correspond to the reference signs in FIG. 2.

The strand shape of the sealing profile has the result that, after the production of the sealing profile, the fastening element 12 is initially a one-piece molded-on/extruded “C” strip running in the longitudinal extent x-D of the sealing profile, which, in terms of material, forms a unit with the main body 1 of the sealing profile.

In order for the sealing profile to be clipped into the inner sill part B2, in the material of the inner sill part B2 there are arranged substantially rectangular openings 17 (at least one opening) or slotted holes (at least one slotted hole), which, in the assembled state, correspond to the position and the geometric shape to the described outer contour of the fastening element 12. It is, in this case provided that, after the production of the sealing profile, the one-piece “C” strip strand running in the longitudinal extent x-D of the sealing profile is cut appropriately so as to form individual C-form clips or individual C-form strips, which can be fitted into corresponding openings provided for this purpose 16 in such a way, that in the assembled state the already explained rear engagement by the undercuts 12A of the fastening element 12 takes place.

In addition, by analogy with reference to the conventional sealing profile, in the case of the sealing profile according to disclosed embodiments, the inner window-sealing abutment lips S10, in particular, two inner window shaft seals are arranged and formed. Also, in FIG. 2, the reference sign S10′ shows the position of the window-sealing abutment lip with the window pane F closed and the reference sign S10″ shows the window-sealing abutment lip S10 with the window pane F open.

In at least one configuration, also provided is a corrosion protection seal, which extends in the longitudinal extent x-B of the sill and is arranged in such a way that, at the transition in which the inner sill part 2 is inserted at the end into the open “U” of the u-shaped bent fold B3, a corrosion protection seal 18 is provided, avoiding corrosion at this transition point.

### LIST OF REFERENCE SIGNS

B1 Outer sill part
B2 Inner sill part
B12 Upper sill edge
SB3 Fold (standing)
B4 Reinforcing part
F Window pane
S1 Main body
S2 Metal insert
S3 Clamping lips
S4 Clamping surfaces
S5 Rubber protective layer
S6 Rear hook
S7 Damping lip
′ Closed state of the window pane F
″ Open state of the window pane F below at least one window-side lip
S8 Window-shaft sealing lip
S8′ Window-shaft sealing lip with window pane closed
S8″ window-shaft sealing lip with window pane closed
S9 Sliding coating
S10 Window-pane sealing abutment lip
S10′ Window-pane sealing abutment lip with window pane closed
S10″ Window-pane sealing abutment lip with window pane open
S11 Sliding coating
B3 Fold (standing)
1 Main body
7 Damping lip
8 Window-shaft sealing lip
8′ Window-shaft sealing lip with window pane closed
8″ Window-shaft sealing lip with window pane fully open
9 Sliding coating
12 Fastening element
12A Undercut
13 Projection
14 Supporting lip
15 Damping lip
16 Coating
17 Opening
18 Corrosion protection seal
S Gap
X Longitudinal extent of a motor vehicle (representation at the top in FIG. 2)
x-B Longitudinal extent of a sill (representation at the top in FIG. 2)
x-D Longitudinal extent of a sealing profile (FIG. 3)

1. A sealing profile formed in one piece of an elastomeric material, the sealing profile comprising:
a main body;
at least one fastening element;
at least one window-shaft sealing lip; and
at least one supporting lip,
wherein the at least one fastening element, the at least one window-shaft sealing lip, and the at least one supporting lip are molded on the main body by material-bonding.

2. The sealing profile of claim 1, wherein the at least one window-shaft sealing lip is formed at its free end as a straight lip or as an angled lip.

3. The sealing profile of claim 1, wherein the sealing profile comprises a first and a second window-shaft sealing lip, which are molded on the main body by material-bonding, wherein the first window-shaft sealing lip is formed at its free end as a straight lip or as an angled lip and the second window-shaft sealing lip is formed at its free end as a straight lip.

4. The sealing profile of claim 1, wherein the main body and the at least one fastening element are formed homogeneously from a stiffer elastomeric material than the at least one window-shaft sealing lip and the supporting lip or the first and second window-shaft sealing lips and the supporting lip.

5. The sealing profile of claim 4, wherein on a side of the sealing profile on which the at least one fastening element is arranged, the sealing profile comprises a projection with a supporting surface, wherein the projection is formed by material-bonding from the stiffer elastomeric material of the main body and is molded on the main body.

6. The sealing profile of claim 4, wherein on a side of the sealing profile opposite from the at least one fastening element, the sealing profile comprises a damping lip formed by material-bonding from the stiffer elastomeric material of the main body and is molded on the main body.

7. The sealing profile of claim 1, wherein, in the cross section transverse to a longitudinal extent of the sealing profile, the at least one fastening element is geometrically formed substantially as a “C” shape, wherein a web-like leg of the “C” shape is molded on the main body in a material-bonding manner, while the other leg of the “C” shape forms an open end.

8. The sealing profile of claim 7, wherein both the web-like leg in an area of the molded-on web and the other leg, have substantially, at their open end, an undercut, which respectively form a step, wherein the two steps form stepped surfaces directed parallel to the main body and stepped surfaces orthogonal to the main body.

9. The sealing profile of claim 1, wherein the supporting lip is formed as an L-shape arranged near the at least one fastening element, on a side of the sealing profile on which the at least one fastening element and the projection are arranged, wherein the at least one fastening element is arranged between the projection and the supporting lip.

10. The sealing profile of claim 1, wherein the at least one fastening element is formed as a “C”-shaped clip or as a “C”-shaped clip strip.

11. A sealing profile arrangement in an installation space lying between a sill and a window pane, the arrangement comprising:
a sealing profile in one piece of an elastomeric material including a main body, at least one fastening element, at least one window-shaft sealing lip, and at least one supporting lip, wherein the at least one fastening element, the at least one window-shaft sealing lip, and the at least one supporting lip are molded on the main body by material-bonding,
wherein the sill forms a gap with a predeterminable clearance with respect to the window pane,
wherein an upper sill edge extends in its longitudinal extent in relation to the window pane that can be reversibly opened orthogonal to the upper sill edge,
wherein the sealing profile, in an installation state, is fastened on an inner side of the sill by at least one fastening element such that the at least one fastening element is inserted through at least one opening provided in the sill,
wherein, simultaneously, in the installation state, at least one supporting lip is supported on the inner side of the sill, and at least one window-shaft sealing lip is positioned in the installation space such that the window-shaft sealing lip closes the gap between the sill and the window pane with the predeterminable clearance both on a window side and on the sill side in a sealing manner,
wherein a highest point of the window-shaft sealing lip is arranged in the gap between the sill and the window pane such that the highest point of the window-shaft sealing lip is positioned below an upper sill edge of the sill.

12. The arrangement of claim 11, wherein, simultaneously, in the installation state, at least one projection is supported on the inner side of the sill.

13. The arrangement of claim 11, wherein, the at least one window-shaft sealing lip is formed at its free end as a straight lip or an angled lip so that the straight lip or the angled lip on both sides of the highest point of the window-shaft sealing lip sealingly abuts the sill side below the upper sill edge as well as the window side.

14. The arrangement of claim 11, wherein the sealing profile includes a first and a second window-shaft sealing lip, wherein the first window-shaft sealing lip is formed at its free end as a straight lip or as an angled lip and the second window-shaft sealing lip is formed at its free end as a straight lip, wherein the first window-shaft sealing lip, in the installation state of the sealing profile, closes the gap between the sill and the window pane with the predeterminable clearance so as to seal the gap so that the straight lip or the angled lip on both sides of the highest point of the window-shaft sealing lip is positioned below the upper sill edge and sealingly abuts the sill side and, the window side, wherein the highest point of the first window-shaft sealing lip is arranged in the gap between the sill and the window pane such that the highest point of the window-shaft sealing lip is positioned below the upper sill edge, while the second window-shaft sealing lip in the installation state is positioned in the installation space below the first window-shaft sealing lip and its straight lip sealingly abuts only on the window side.

15. The arrangement of claim 11, wherein, an outer sill part is formed in the near-window area as folded, wherein the formed fold forms the seal-free upper sill edge, wherein, in a fold gap opposite from the upper sill edge, there is arranged the inner sill part, in which the at least one opening is provided, wherein at least the near-window fold is arranged with its upper sill edge oriented with respect to the window pane in three-dimensional space such that the upper sill edge of the sill faces the window pane, while the sill parts of the sill outside the near-window fold are formed and arranged to run substantially coaxial to the window pane.
